(19) United States
(12) Patent Application Publication
(10) Pub. No.: US 2026/0333167 A1
(43) Pub. Date: Oct. 22, 2026

(54) TECHNIQUES FOR TRANSMISSION RECEPTION POINT SWITCHING DURING REPETITIONS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 19/099,532

(22) PCT Filed: Sep. 29, 2022
(86) PCT No.: PCT/CN2022/122429

§ 371 Date: Jan. 29, 2025

(51) Int. Cl. H04W 36/08; H04B 7/06; H04W 72/0446; H04W 72/231; H04W 80/02

(52) U.S. Cl. CPC H04W 36/085; H04B 7/06968; H04W 72/0446; H04W 72/231; H04W 80/02

(57) ABSTRACT

Various aspects of the present disclosure generally relate to wireless communication. In some aspects, a user equipment (UE) may receive an indication to switch from multiple transmission reception point (multi-TRP) communication using multiple transmission configuration indicator (TCI) states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The UE may communicate using the single TCI state or the multiple TCI states, according to the indication, based at least in part on a starting repetition for a pattern of TCI state-to-repetition mapping. Numerous other aspects are described.

### FIELD OF THE DISCLOSURE

Aspects of the present disclosure generally relate to wireless communication and to techniques and apparatuses for transmission reception point (TRP) switching during repetitions.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by an apparatus of a user equipment (UE). The method may include receiving an indication to switch from multiple transmission reception point (multi-TRP) communication using multiple transmission configuration indicator (TCI) states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The method may include communicating using the single TCI state or the multiple TCI states, according to the indication, based at least in part on a starting repetition for a pattern of TCI state-to-repetition mapping.

Some aspects described herein relate to a method of wireless communication performed by an apparatus of a network node. The method may include transmitting an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The method may include communicating, according to the indication, based at least in part on a starting repetition for a pattern of TCI state-to-repetition mapping.

Some aspects described herein relate to an apparatus for wireless communication at a UE. The apparatus may include a memory and one or more processors coupled to the memory. The one or more processors may be configured to receive an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The one or more processors may be configured to communicate using the single TCI state or the multiple TCI states, according to the indication, based at least in part on a starting repetition for a pattern of TCI state-to-repetition mapping.

Some aspects described herein relate to an apparatus for wireless communication at a network node. The network node may include a memory and one or more processors coupled to the memory. The one or more processors may be configured to transmit an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The one or more processors may be configured to communicate, according to the indication, based at least in part on a starting repetition for a pattern of TCI state-to-repetition mapping.

Some aspects described herein relate to a non-transitory computer-readable medium that stores a set of instructions for wireless communication by a UE. The set of instructions, when executed by one or more processors of the UE, may cause the UE to receive an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The set of instructions, when executed by one or more processors of the UE, may cause the UE to communicate using the single TCI state or the multiple TCI states, according to the indication, based at least in part on a starting repetition for a pattern of TCI state-to-repetition mapping.

Some aspects described herein relate to a non-transitory computer-readable medium that stores a set of instructions for wireless communication by a network node. The set of instructions, when executed by one or more processors of the network node, may cause the network node to transmit an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The set of instructions, when executed by one or more processors of the network node, may cause the network node to communicate, according to the indication, based at least in part on a starting repetition for a pattern of TCI state-to-repetition mapping.

Some aspects described herein relate to an apparatus for wireless communication. The apparatus may include means for receiving an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The apparatus may include means for communicating using the single TCI state or the multiple TCI states, according to the indication, based at least in part on a starting repetition for a pattern of TCI state-to-repetition mapping.

Some aspects described herein relate to an apparatus for wireless communication. The apparatus may include means for transmitting an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The apparatus may include means for communicating, according to the indication, based at least in part on a starting repetition for a pattern of TCI state-to-repetition mapping.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example di saggregated base station architecture, in accordance with the present disclosure.

FIG. 4 illustrates an example logical architecture of a distributed radio access network (RAN), in accordance with the present disclosure.

FIG. 5 is a diagram illustrating an example of multiple transmission reception point (multi-TRP) communication, in accordance with the present disclosure.

FIG. 6 is a diagram illustrating examples of multi-TRP operation, in accordance with the present disclosure.

FIG. 7 is a diagram illustrating examples of transmission configuration indicator (TCI) state-to-repetition mapping, in accordance with the present disclosure.

FIG. 8 is a diagram of an example associated with TRP switching during repetitions, in accordance with the present disclosure.

FIG. 9 is a diagram of examples associated with TRP switching during repetitions, in accordance with the present disclosure.

FIG. 10 is a diagram of examples associated with TRP switching during repetitions, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

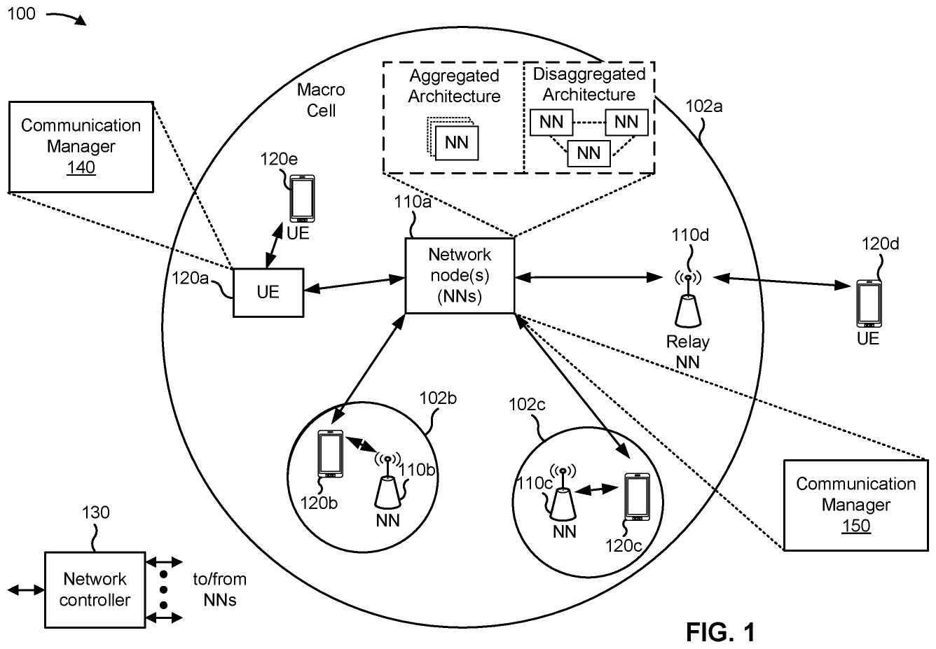

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IOT) devices, or may be implemented as NB-IOT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive an indication to switch from multi-TRP communication using multiple transmission configuration indicator (TCI) states to single-TRP communication using a single TCI state, or to switch from single-TRP communication using the single TCI state to multi-TRP communication using the multiple TCI states, the indication indicating a time for switching that is between repetitions of a plurality of repetitions of a communication; and communicate using the single TCI state or the multiple TCI states, according to the indication, based at least in part on a starting repetition for a pattern of TCI state-to-repetition mapping. Additionally, or alternatively, the communication manager 140 may perform one or more other operations described herein.

In some aspects, the network node 110 may include a communication manager 150. As described in more detail elsewhere herein, the communication manager 150 may transmit an indication to switch from multiple multi-TRP communication using multiple TCI states to single-TRP communication using a single TCI state, or to switch from single-TRP communication using the single TCI state to multi-TRP communication using the multiple TCI states, the indication indicating a time for switching that is between repetitions of a plurality of repetitions of a communication; and communicate, according to the indication, based at least in part on a starting repetition for a pattern of TCI state-to-repetition mapping. Additionally, or alternatively, the communication manager 150 may perform one or more other operations described herein.

As indicated above, FIG. 1 is provided as an example. Other examples may differ from what is described with regard to FIG. 1.

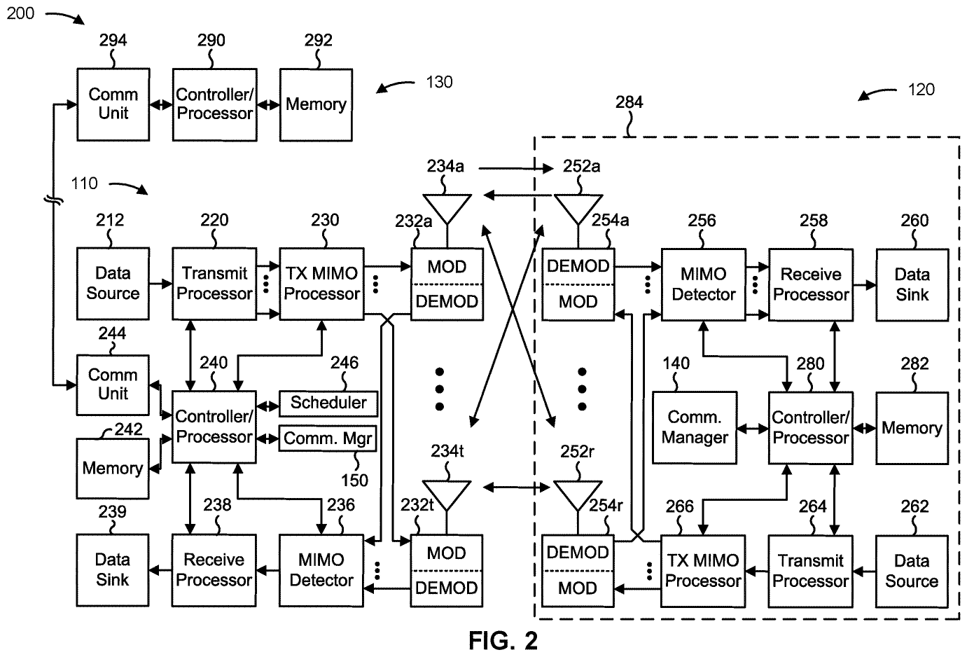

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

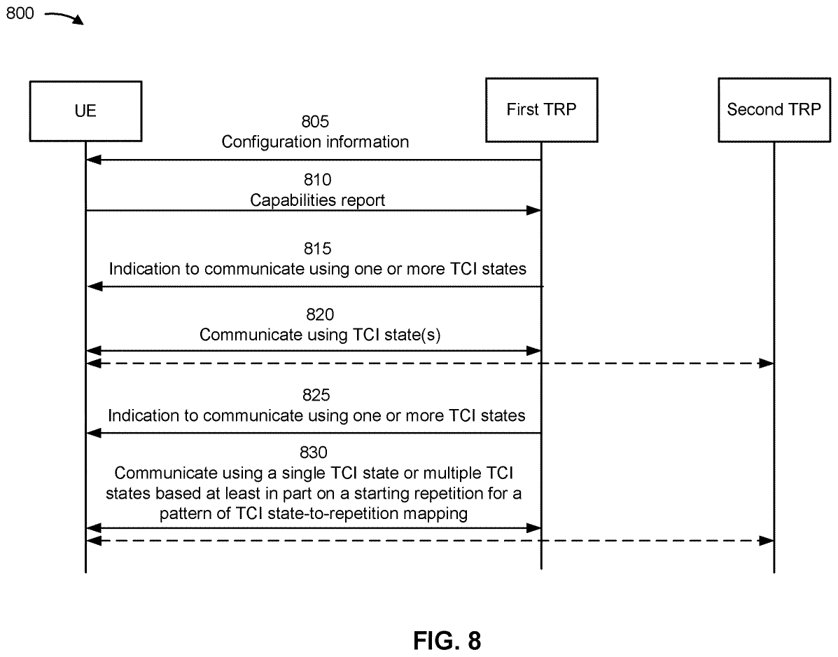

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 8-14).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 8-14).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

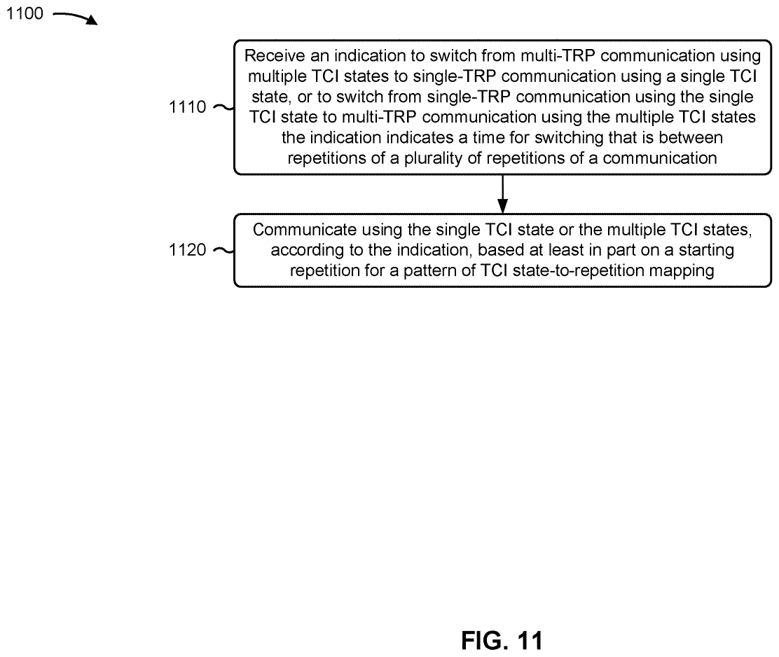

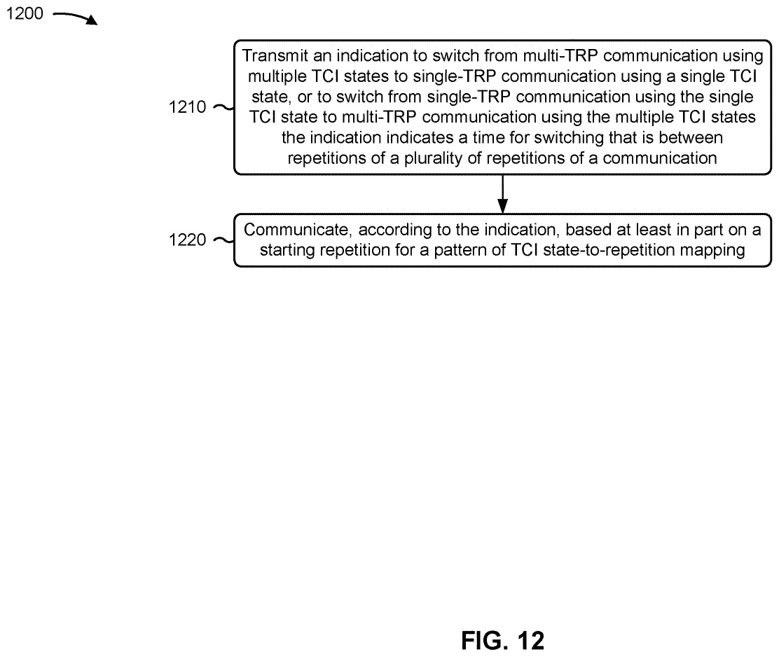

The controller/processor 240 of the network node 110, the controller/processor 280 of the UE 120, or any other component(s) of FIG. 2 may perform one or more techniques associated with TRP switching during repetitions, as described in more detail elsewhere herein. For example, the controller/processor 240 of the network node 110, the controller/processor 280 of the UE 120, or any other component(s) (or combinations of components) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for receiving an indication to switch from multi-TRP communication using multiple TCI states to single-TRP communication using a single TCI state, or to switch from single-TRP communication using the single TCI state to multi-TRP communication using the multiple TCI states, the indication indicating a time for switching that is between repetitions of a plurality of repetitions of a communication; and/or means for communicating using the single TCI state or the multiple TCI states, according to the indication, based at least in part on a starting repetition for a pattern of TCI state-to-repetition mapping. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication to switch from multi-TRP communication using multiple TCI states to single-TRP communication using a single TCI state, or to switch from single-TRP communication using the single TCI state to multi-TRP communication using the multiple TCI states, the indication indicating a time for switching that is between repetitions of a plurality of repetitions of a communication; and/or means for communicating, according to the indication, based at least in part on a starting repetition for a pattern of TCI state-to-repetition mapping. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

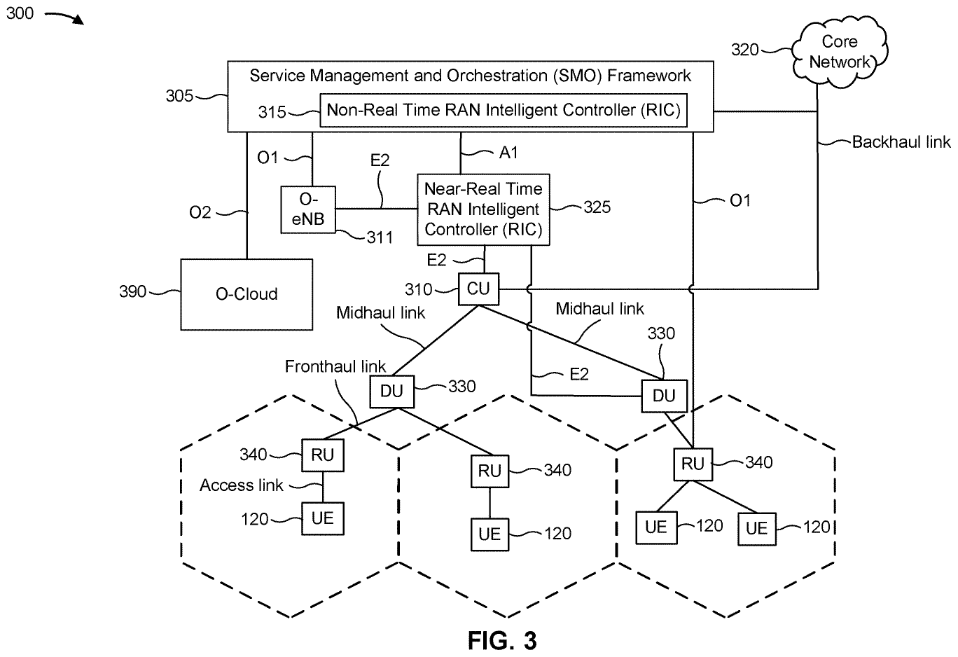

FIG. 3 is a diagram illustrating an example di saggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as A1 interface policies).

As indicated above, FIG. 3 is provided as an example. Other examples may differ from what is described with regard to FIG. 3.

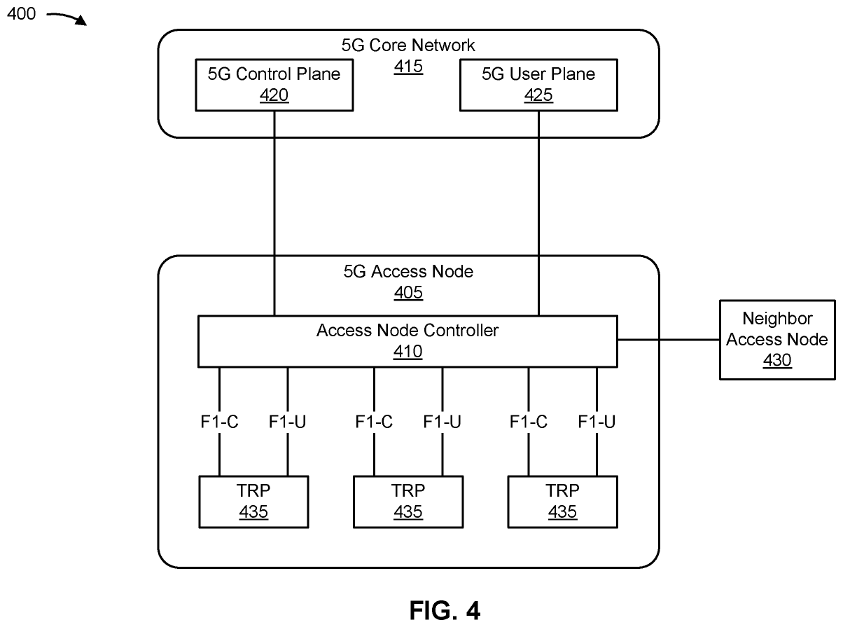

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a DU and/or an RU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

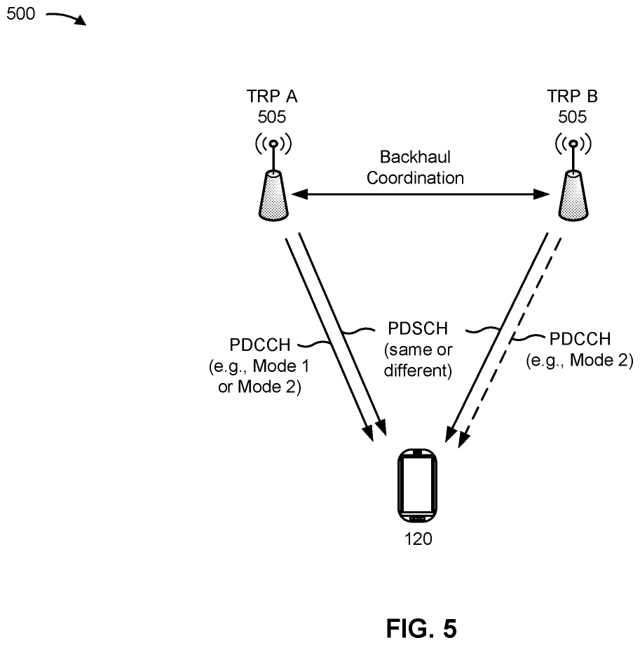

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

A TCI state may be associated with a beam. For example, a TCI state may indicate a directionality or a characteristic of a beam, such as one or more QCL properties of the beam. A QCL property may include, for example, a Doppler shift, a Doppler spread, an average delay, a delay spread, or spatial receive parameters, among other examples.

A unified TCI indication may indicate a common beam, which may refer to a beam for use in transmitting and/or receiving multiple channels and/or reference signals. A unified TCI indication may be a first type (Type 1) that uses a joint TCI state to indicate a common beam for at least one downlink channel and/or downlink reference signal and at least one uplink channel and/or uplink reference signal. The Type 1 unified TCI may be for at least a UE-specific PDCCH, PDSCH, physical uplink control channel (PUCCH), and/or physical uplink shared channel (PUSCH). A unified TCI indication may be a second type (Type 2) that uses a separate downlink TCI state to indicate a common beam for more than one downlink channel and/or downlink reference signal. The Type 2 unified TCI may be for at least a UE-specific PDCCH and/or PDSCH. A unified TCI indication may be a third type (Type 3) that uses a separate uplink TCI state to indicate a common beam for more than one uplink channel and/or uplink reference signal. The Type 3 unified TCI may be for at least a UE-specific PUCCH and/or PUSCH. In some examples, a unified TCI indication may indicate multiple downlink TCI states and/or multiple uplink TCI states for multi-TRP use. For example, a unified TCI indication may indicate a TCI codepoint that maps to multiple TCI states.

A unified TCI indication may be provided to the UE 120 in signaling from a network node (e.g., the first TRP 505 or the second TRP 505). For example, a unified TCI indication may be provided in DCI and/or a MAC control element (MAC-CE). An application time for one or more beams indicated by the unified TCI indication may be counted from an end of the DCI/MAC-CE or from an end of a communication of acknowledgment feedback for the DCI/MAC-CE.

As indicated above, FIG. 5 is provided as an example. Other examples may differ from what is described with respect to FIG. 5.

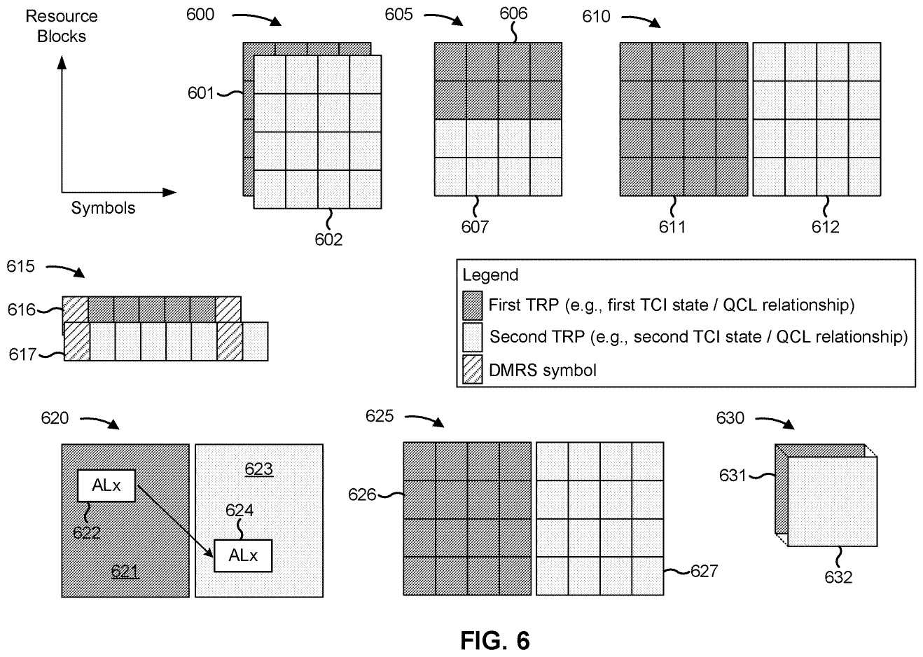

FIG. 6 is a diagram illustrating examples of multi-TRP operation, in accordance with the present disclosure.

Examples 600, 605, 610, and 615 relate to multi-TRP PDSCH operation. In examples 600, 605, and 610, PDSCHs for multiple TRPs may be scheduled using a single DCI communication. In example 600, PDSCH resource 601 for a first TRP may be spatial division multiplexed with PDSCH resource 602 for a second TRP. In example 605, PDSCH resource 606 for a first TRP may be frequency division multiplexed with PDSCH resource 607 for a second TRP. In example 610, PDSCH resource 611 for a first TRP may be time division multiplexed with PDSCH resource 612 for a second TRP. In example 615, PDSCHs for multiple TRPs may be scheduled using multiple DCI communications. As shown, DMRS symbols in a first time resource allocation 616 associated with a first TRP may be aligned in time with DMRS symbols in a second time resource allocation 617 associated with a second TRP.

Example 620 relates to multi-TRP DCI repetition. As shown, a first control resource set (CORESET) 621 associated with a first TRP may carry a first repetition 622 of DCI, and a second CORESET 623 associated with a second TRP may carry a second repetition 624 of DCI. As shown, the same aggregation level (shown as “ALx”) may be used for the first repetition 622 and the second repetition 624 of the DCI. Example 625 relates to multi-TRP PUCCH or PUSCH repetition. As shown, PUCCH or PUSCH resource 626 for a first TRP may be time division multiplexed with PUCCH or PUSCH resource 627 for a second TRP. In example 630, a single frequency network (SFN) may be used for PDCCH and/or PDSCH transmissions. As shown, a PDCCH or PDSCH resource 631 for a first TRP may occupy a same time and frequency as a PDCCH or PDSCH resource 632 for a second TRP.

As indicated above, FIG. 6 is provided as an example. Other examples may differ from what is described with respect to FIG. 6.

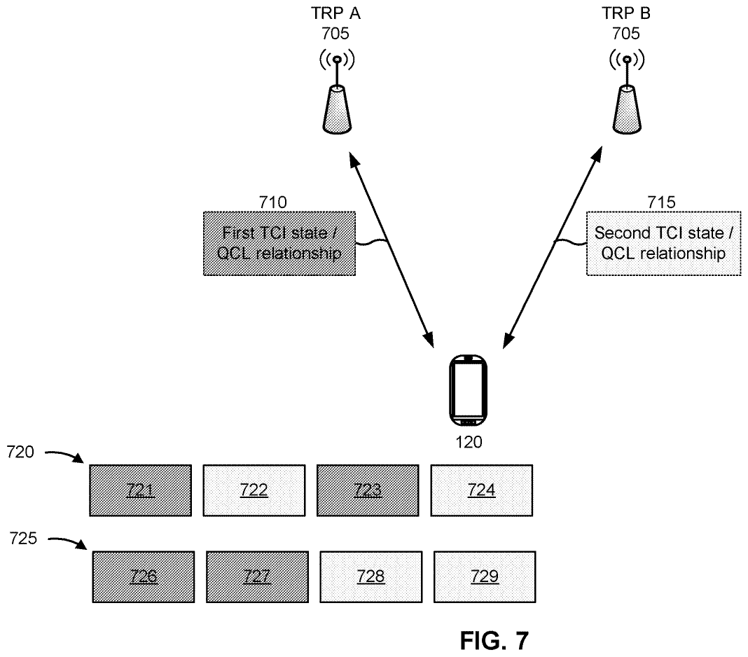

FIG. 7 is a diagram illustrating examples of TCI state-to-repetition mapping, in accordance with the present disclosure. As shown in FIG. 7, multiple TRPs 705 may communicate with the same UE 120. A TRP 705 may correspond to a TRP 435 described above in connection with FIG. 4 or a TRP 505 described above in connection with FIG. 5.

The multiple TRPs 705 (shown as TRP A and TRP B) may communicate with the UE 120 using multiple beams. For example, a first TRP 705 (TRP A) may communicate with the UE 120 using a first beam 710, corresponding to a first TCI state or QCL relationship, and a second TRP 705 (TRP B) may communicate with the UE 120 using a second beam 715, corresponding to a second TCI state or QCL relationship. Repetitions of a communication may be time division multiplexed and may alternate between using the first beam 710 and the second beam 715 according to a TCI-to-repetition mapping. In example 720, a cyclic mapping is used. According to the cyclic mapping, a first repetition 721 of a communication may use the first beam 710 associated with the first TRP 705, a second repetition 722 of the communication may use the second beam 715 associated with the second TRP 705, a third repetition 723 of the communication may use the first beam 710 associated with the first TRP 705, and a fourth repetition 724 of the communication may use the second beam 715 associated with the second TRP 705 (e.g., the cyclic mapping uses an A-B-A-B pattern). In example 725, a sequential mapping is used. According to the sequential mapping, a first repetition 726 of a communication may use the first beam 710 associated with the first TRP 705, a second repetition 727 of the communication may use the first beam 710 associated with the first TRP 705, a third repetition 728 of the communication may use the second beam 715 associated with the second TRP 705, and a fourth repetition 729 of the communication may use the second beam 715 associated with the second TRP 705 (e.g., the sequential mapping uses an A-A-B-B pattern).

When repetitions are used, a transmitter (e.g., the UE 120 or a TRP 705) repeats transmission of a communication multiple times. For example, the transmitter may transmit an initial communication and may repeat transmission of (e.g., may retransmit) that communication one or more times. In some examples, a repeated transmission (sometimes referred to as a retransmission) may include the same encoded bits (e.g., information bits and parity bits) as the initial transmission and/or as another repeated transmission (e.g., where a same redundancy version is used across repetitions). Alternatively, a repeated transmission may include different encoded bits (e.g., a different combination of information bits and/or parity bits) than the initial transmission and/or another repeated transmission (e.g., where different redundancy versions are used across repetitions). As used herein, the term “repetition” is used to refer to the initial communication and is also used to refer to a repeated transmission of the initial communication. For example, if the UE 120 is configured to transmit four repetitions, then the UE 120 may transmit an initial transmission and may transmit three repeated transmissions of that initial transmission. Thus, each transmission (regardless of whether the transmission is an initial transmission or a retransmission) is counted as a repetition.

In some cases, the UE 120 may receive an indication to use a single TCI state for single-TRP communication. Thereafter, the UE 120 may receive an additional indication to use multiple TCI states for multi-TRP communication. The additional indication may indicate an application time for the multiple TCI states that is within a communication occasion (e.g., a transmission occasion or a reception occasion) for a plurality of repetitions that are to be transmitted or received by the UE 120. In some other cases, the UE 120 may receive an indication to use multiple TCI states for multi-TRP communication. Thereafter, the UE 120 may receive an additional indication to use a single TCI state for single-TRP communication. The additional indication may indicate an application time for the single TCI state that is within a communication occasion (e.g., a transmission occasion or a reception occasion) for a plurality of repetitions that are to be transmitted or received by the UE 120. In both cases, there is an ambiguity as to when the UE 120 is to switch from using single-TRP communication to using multi-TRP communication, or from using multi-TRP communication to using single-TRP communication, as well as an ambiguity as to a pattern of TCI state-to-repetition mapping that the UE 120 is to use upon switching. As a result, a performance of communications at the UE 120 may suffer.

In some techniques and apparatuses described herein, a starting repetition for a pattern of TCI state-to-repetition mapping may be used in connection with switching from using single-TRP communication to using multi-TRP communication, or from using multi-TRP communication to using single-TRP communication. For example, the starting repetition may be used when an indication to switch from a single TCI state to multiple TCI states, or from multiple TCI states to a single TCI state, indicates a time for the switching that is between repetitions of a plurality of repetitions. In some aspects, when the UE 120 is to switch from single-TRP communication (e.g., using a single TCI state) to multi-TRP communication (e.g., using multiple TCI states), a starting repetition may be a first repetition of the plurality of repetitions or a first repetition, of the plurality of repetitions, following the time for switching. In some aspects, when the UE 120 is to switch from multi-TRP communication (e.g., using multiple TCI states) to single-TRP communication (e.g., using a single TCI state), a starting repetition may be a first repetition of a plurality of subsequent repetitions or a first repetition, of the plurality of repetitions, following the time for switching. In this way, the UE 120 and one or more TRPs may communicate, when switching between TRPs, using a starting repetition, thereby improving a performance of communications at the UE 120.

As indicated above, FIG. 7 is provided as an example. Other examples may differ from what is described with respect to FIG. 7.

FIG. 8 is a diagram of an example 800 associated with TRP switching during repetitions, in accordance with the present disclosure. As shown in FIG. 8, multiple TRPs (e.g., TRPs 435, 505, and/or 705) may communicate with a UE (e.g., UE 120). In some aspects, the UE and the multiple TRPs may be part of a wireless network (e.g., wireless network 100).

As shown by reference number 805, a first TRP (and/or a second TRP) may transmit, and the UE may receive, configuration information. In some aspects, the UE may receive the configuration information via one or more of RRC signaling, one or more MAC-CEs, and/or DCI, among other examples. In some aspects, the configuration information may include an indication of one or more configuration parameters (e.g., already known to the UE and/or previously indicated by the first network node or other network device) for selection by the UE, and/or explicit configuration information for the UE to use to configure the UE, among other examples.

In some aspects, the configuration information may indicate a configuration for a PDSCH, a PUSCH, and/or a PUCCH. In some aspects, the configuration information may configure repetitions for the PDSCH, the PUSCH, and/or the PUCCH. The repetitions may be inter-slot repetitions, which may refer to repetitions of a communication that are communicated in respective slots. In some aspects, the configuration information may indicate a type of a mapping for the repetitions, such as a cyclic mapping or a sequential mapping. In some aspects, the configuration information may indicate (e.g., in connection with the repetitions) a semi-persistent scheduling (SPS) configuration for the PDSCH, a configured grant configuration for the PUSCH, and/or a periodic channel state reporting configuration for the PUCCH.

The UE may configure itself based at least in part on the configuration information. In some aspects, the UE may be configured to perform one or more operations described herein based at least in part on the configuration information. As shown by reference number 810, the UE may transmit, and the first TRP (and/or the second TRP) may receive, a capabilities report. In some aspects, the capabilities report may indicate UE support for multi-TRP communication.

As shown by reference number 815, the UE may receive, and the first TRP (and/or the second TRP) may transmit, an indication to communicate using one or more TCI states. The indication may indicate that the UE is to communicate using the TCI state(s) until the UE receives an indication otherwise (e.g., the TCI state(s) are applicable for use for a current allocation as well as for future allocations). In some aspects, the indication may indicate that the UE is to communicate using a single TCI state (e.g., using a single beam) for single-TRP communication. In some aspects, the indication may indicate that the UE is to communicate using multiple TCI states (e.g., using multiple beams) for multi-TRP communication. The indication may be in DCI and/or in a MAC-CE. In some aspects, the indication may be a unified TCI indication (e.g., which may indicate a TCI codepoint that maps to a single TCI state or multiple TCI states).

As shown by reference number 820, the UE may communicate using the indicated TCI state(s) (e.g., using beam(s) associated with the indicated TCI state(s)) for a plurality of repetitions of a communication (e.g., in accordance with the configuration information). For example, if the single TCI state is indicated, the UE may communicate with the first TRP using the single TCI state for the plurality of repetitions (e.g., inter-slot repetitions). That is, the UE may transmit or receive, and the first TRP may receive or transmit, the plurality of repetitions. As another example, if the multiple TCI states are indicated, the UE may communicate with the first TRP and the second TRP using the multiple TCI states (e.g., using respective TCI states for each TRP) for the plurality of repetitions. That is, the UE may transmit or receive, and the first TRP may receive or transmit, one or more of the repetitions using a first TCI state, and the UE may transmit or receive, and the second TRP may receive or transmit, one or more of the repetitions using a second TCI state. The multiple TCI states may be mapped to the repetitions using cyclic mapping or sequential mapping (e.g., in accordance with the configuration information).

As shown by reference number 825, the UE may receive, and the first TRP (and/or the second TRP) may transmit, an indication to communicate using one or more TCI states. The indication may indicate that the UE is to communicate using the TCI state(s) until the UE receives an indication otherwise (e.g., the TCI state(s) are applicable for use for a current allocation as well as for future allocations). The indication may be in DCI and/or in a MAC-CE. In some aspects, the indication may be a unified TCI indication (e.g., which may indicate a TCI codepoint that maps to a single TCI state or multiple TCI states).

In some aspects, the indication may indicate that the UE is to switch from single-TRP communication using a single TCI state to multi-TRP communication using multiple TCI states. That is, if the indication shown at reference number 815 indicates that the UE is to communicate using a single TCI state (e.g., for single-TRP communication), then the indication shown at reference number 825 may indicate that the UE is to communicate using multiple TCI states (e.g., for multi-TRP communication). In some aspects, the indication may indicate that the UE is to switch from multi-TRP communication using multiple TCI states to single-TRP communication using a single TCI state. That is, if the indication shown at reference number 815 indicates that the UE is to communicate using multiple TCI states (e.g., for multi-TRP communication), then the indication shown at reference number 825 may indicate that the UE is to communicate using a single TCI state (e.g., for single-TRP communication).

In some aspects, the indication may indicate a time for applying the TCI state(s) that are indicated (which may be referred to as an “application time” for the TCI state(s)). That is, the indication may indicate the time for the switching. The time for the switching may be during the plurality of repetitions. For example, the time for the switching may be between repetitions of the plurality of repetitions (e.g., after an end of a repetition or during transmission or reception of a repetition). As an example, the time for switching may be within a communication occasion (e.g., a transmission occasion for a PUCCH or a reception occasion for a PDSCH or PUSCH) for the plurality of repetitions. For example, the time for switching to a single TCI state may be in the middle of the UE transmitting or receiving the plurality of repetitions using multiple TCI states. As another example, the time for switching to multiple TCI states may be in the middle of the UE transmitting or receiving the plurality of repetitions using a single TCI state.

As shown by reference number 830, the UE may communicate using a single TCI state (e.g., a single beam) or multiple TCI states (e.g., multiple beams), according to the indication (e.g., if the indication shown at reference number 825 indicates a single TCI state, the UE may communicate using the single TCI state, or if the indication shown at reference number 825 indicates multiple TCI states, the UE may communicate using the multiple TCI states), based at least in part on a starting repetition for a pattern of TCI state-to-repetition mapping. The UE may apply the indicated TCI state(s) following the indicated application time. However, a particular repetition at which the UE starts to use the indicated TCI state(s) and/or a mapping pattern in which the UE uses the indicated TCI state(s) may be based at least in part on a particular starting repetition. That is, when the switching from a single TCI state to multiple TCI states, or from multiple TCI states to a single TCI state, is to occur, as well as a pattern of TCI state-to-repetition mapping that is to be used, may be a function of the starting repetition.

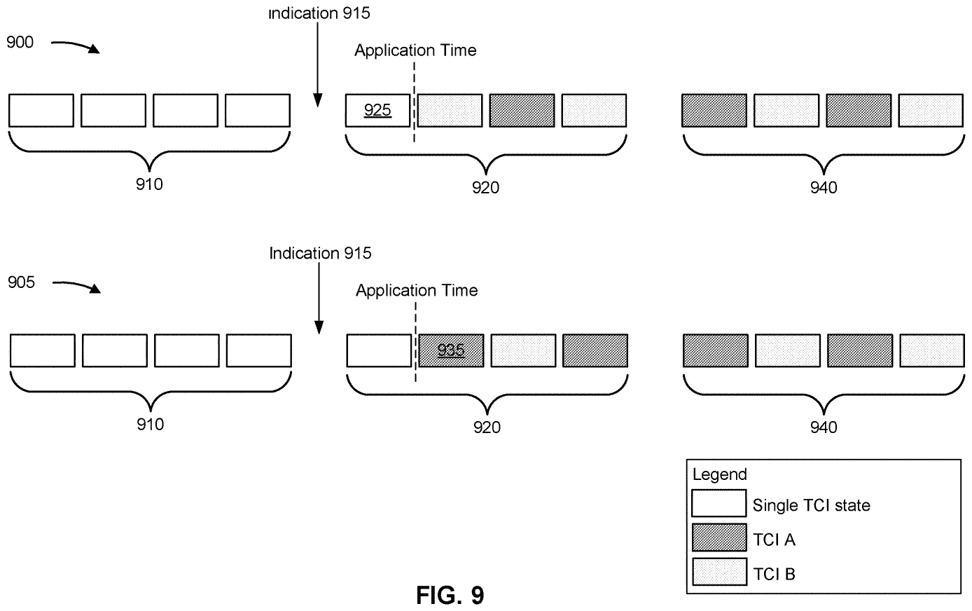

In some aspects, if the UE is switching from a single TCI state to multiple TCI states, the starting repetition for the pattern may be a first repetition of the plurality of repetitions (e.g., at a beginning of the communication occasion). Thus, the pattern for cyclic mapping or sequential mapping may be counted starting from the first repetition of the plurality of repetitions (e.g., which may be a repetition that is before the application time). In some aspects, if the UE is switching from a single TCI state to multiple TCI states, the starting repetition for the pattern may be a first repetition, of the plurality of repetitions, following the application time. Thus, the pattern for cyclic mapping or sequential mapping may be counted starting from the first repetition following the application time. Examples of the foregoing are provided in connection with FIG. 9.

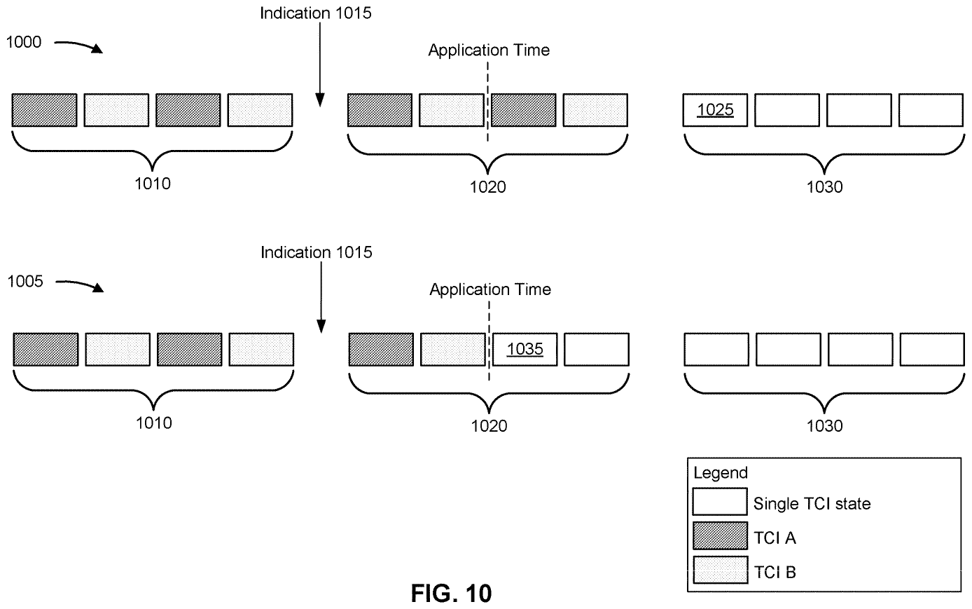

In some aspects, if the UE is switching from multiple TCI states to a single TCI state, the starting repetition for the pattern may be a first repetition of a plurality of subsequent repetitions (e.g., inter-slot repetitions) of a communication (e.g., a different communication than the communication of the plurality of repetitions). Thus, the UE may complete the plurality of repetitions using the multiple TCI states, and the UE may begin using the single TCI state for the plurality of subsequent repetitions. In some aspects, if the UE is switching from multiple TCI states to a single TCI state, the starting repetition for the pattern may be a first repetition, of the plurality of repetitions, following the application time. Thus, the UE may switch from using multiple TCI states to using a single TCI state in the middle of the plurality of repetitions. Examples of the foregoing are provided in connection with FIG. 10.

In this way, the UE and the TRPs may communicate based at least in part on a starting repetition, thereby improving a performance of communications at the UE 120.

As indicated above, FIG. 8 is provided as an example. Other examples may differ from what is described with respect to FIG. 8.

FIG. 9 is a diagram of examples 900, 905 associated with TRP switching during repetitions, in accordance with the present disclosure. Examples 900, 905 may be examples of the techniques described in connection with FIG. 8.

In examples 900, 905, the UE may transmit or receive, and the first TRP (or the second TRP) may receive or transmit, a plurality of repetitions 910 (shown as four inter-slot repetitions) of a communication (e.g., in a communication occasion for the plurality of repetitions 910) using a single TCI state. The UE may receive, and the first TRP (and/or the second TRP) may transmit, an indication 915 that the UE is to switch from using the single TCI state (e.g., a single beam) to using multiple TCI states (e.g., multiple beams). The UE may receive the indication 915 after the plurality of repetitions 910, as shown, before the plurality of repetitions 910, during the plurality of repetitions 910, or the communication of the plurality of repetitions 910 may be the indication. As described herein, the indication may indicate an application time for the multiple TCI states that is during a plurality of repetitions 920 (shown as four inter-slot repetitions) of a communication (e.g., in a communication occasion for the plurality of repetitions 920). For example, the application time may be between repetitions of the plurality of repetitions 920. The UE may then begin to transmit or receive, and the first TRP (or the second TRP) may begin to receive or transmit, the plurality of repetitions 920 using the single TCI state (e.g., prior to the application time for the multiple TCI states).

In example 900, a starting repetition 925 for a pattern of TCI state-to-repetition mapping may be a first repetition of the plurality of repetitions 920 (e.g., at a beginning of the communication occasion). As shown, a cyclic mapping of the multiple TCI states (shown as TCI A and TCI B) may be used, whereby repetitions are mapped according to a pattern of TCI A, TCI B, TCI A, TCI B, and so forth. However, example 900 is equally applicable to a sequential mapping. According to the cyclic mapping from the starting repetition 925, a first repetition of the plurality of repetitions 920 may be mapped to TCI A (e.g., even though the first repetition is before the application time and may be transmitted using the single TCI state), a second repetition of the plurality of repetitions 920 may be mapped to TCI B, a third repetition of the plurality of repetitions 920 may be mapped to TCI A, and a fourth repetition of the plurality of repetitions 920 may be mapped to TCI B. Thus, the UE may transmit or receive, and the first TRP and the second TRP may receive or transmit, the second repetition using TCI B, the third repetition using TCI A, and the fourth repetition using TCI B.

In example 905, a starting repetition 935 for a pattern of TCI state-to-repetition mapping may be a first repetition, of the plurality of repetitions 920, following the application time for the multiple TCI states. As shown, a cyclic mapping of the multiple TCI states (shown as TCI A and TCI B) may be used, whereby repetitions are mapped according to a pattern of TCI A, TCI B, TCI A, TCI B, and so forth. However, example 905 is equally applicable to a sequential mapping. According to the cyclic mapping from the starting repetition 935, a first repetition of the plurality of repetitions 920 may be unmapped, a second repetition of the plurality of repetitions 920 may be mapped to TCI A, a third repetition of the plurality of repetitions 920 may be mapped to TCI B, and a fourth repetition of the plurality of repetitions 920 may be mapped to TCI A. Thus, the UE may transmit or receive, and the first TRP and the second TRP may receive or transmit, the second repetition using TCI A, the third repetition using TCI B, and the fourth repetition using TCI A.

In examples 900, 905, for a plurality of subsequent repetitions 940 (shown as four inter-slot repetitions), a starting repetition for a TCI state-to-repetition mapping may be a first repetition of the plurality of subsequent repetitions 940. Accordingly, a first repetition of the plurality of subsequent repetitions 940 may be mapped to TCI A, a second repetition of the plurality of subsequent repetitions 940 may be mapped to TCI B, a third repetition of the plurality of subsequent repetitions 940 may be mapped to TCI A, and a fourth repetition of the plurality of subsequent repetitions 940 may be mapped to TCI B.

As indicated above, FIG. 9 is provided as an example. Other examples may differ from what is described with respect to FIG. 9.

FIG. 10 is a diagram of examples 1000, 1005 associated with TRP switching during repetitions, in accordance with the present disclosure. Examples 1000, 1005 may be examples of the techniques described in connection with FIG. 8.

In examples 1000, 1005, the UE may transmit or receive, and the first TRP and the second TRP may receive or transmit, a plurality of repetitions 1010 (shown as four inter-slot repetitions) of a communication (e.g., in a communication occasion for the plurality of repetitions 1010) using multiple TCI states. As shown, a cyclic mapping of the multiple TCI states (shown as TCI A and TCI B) may be used, whereby repetitions are mapped according to a pattern of TCI A, TCI B, TCI A, TCI B, and so forth. However, examples 1000, 1005 are equally applicable to a sequential mapping.

The UE may receive, and the first TRP (and/or the second TRP) may transmit, an indication 1015 that the UE is to switch from using the multiple TCI states (e.g., multiple beams) to using a single TCI state (e.g., a single beam). The UE may receive the indication 1015 after the plurality of repetitions 1010, as shown, before the plurality of repetitions 1010, during the plurality of repetitions 1010, or the communication of the plurality of repetitions 1010 may be the indication. As described herein, the indication may indicate an application time for the single TCI state that is during a plurality of repetitions 1020 (shown as four inter-slot repetitions) of a communication (e.g., in a communication occasion for the plurality of repetitions 1020). For example, the application time may be between repetitions of the plurality of repetitions 1020. The UE may then begin to transmit or receive, and the first TRP and the second TRP may begin to receive or transmit, the plurality of repetitions 1020 using the multiple TCI states (e.g., prior to the application time for the single TCI states) in a similar manner as the plurality of repetitions 1010.

In example 1000, a starting repetition 1025 for a pattern of TCI state-to-repetition mapping may be a first repetition of a plurality of subsequent repetitions 1030 (e.g., at a beginning of a communication occasion for the plurality of subsequent repetitions 1030, which are shown as four inter-slot repetitions). In the case of the single TCI state, the pattern of TCI state-to-repetition mapping may result in the single TCI state being mapped to each repetition. Accordingly, following the application time for the single TCI state, the UE may continue to transmit or receive, and the first TRP and the second TRP may continue to receive or transmit, the plurality of repetitions 1020 (e.g., by continuing the pattern of the cyclic mapping). Starting from the starting repetition 1025, the single TCI state may be mapped to the plurality of subsequent repetitions 1030. Thus, the UE may transmit or receive, and the first TRP (or the second TRP) may receive or transmit, the plurality of subsequent repetitions 1030 using the single TCI state.

In example 1005, a starting repetition 1035 for a pattern of TCI state-to-repetition mapping may be a first repetition following the application time for the single TCI state. In the case of the single TCI state, the pattern of TCI state-to-repetition mapping may result in the single TCI state being mapped to each repetition. Accordingly, starting from the starting repetition 1035, the single TCI state may be mapped to repetitions of the plurality of repetitions 1020. Continuing thereafter, the single TCI state may be mapped to the plurality of subsequent repetitions 1030.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with TRP switching during repetitions.

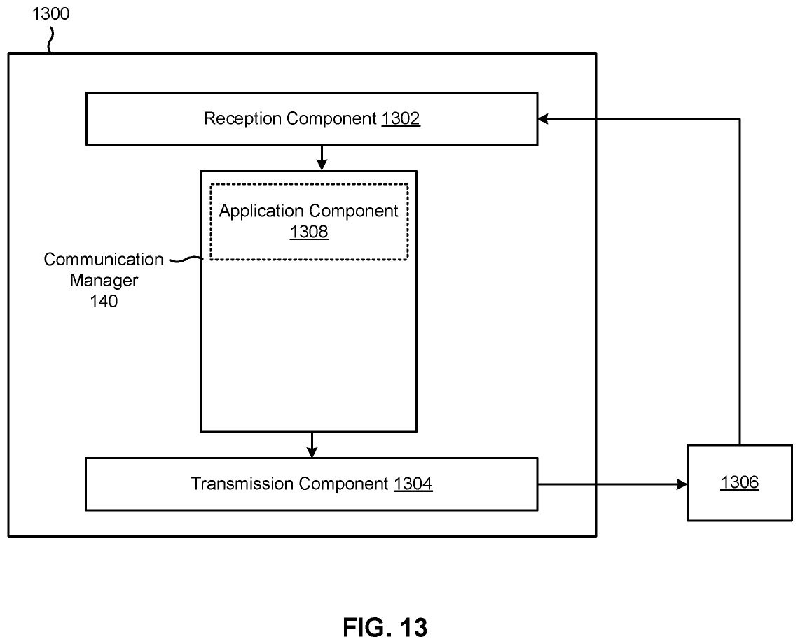

As shown in FIG. 11, in some aspects, process 1100 may include receiving an indication to switch from multi-TRP communication using multiple TCI states to single-TRP communication using a single TCI state, or to switch from single-TRP communication using the single TCI state to multi-TRP communication using the multiple TCI states, the indication indicates a time for switching that is between repetitions of a plurality of repetitions of a communication (block 1110). For example, the UE (e.g., using communication manager 140 and/or reception component 1302, depicted in FIG. 13) may receive an indication to switch from multi-TRP communication using multiple TCI states to single-TRP communication using a single TCI state, or to switch from single-TRP communication using the single TCI state to multi-TRP communication using the multiple TCI states, the indication indicates a time for switching that is between repetitions of a plurality of repetitions of a communication, as described above.

As further shown in FIG. 11, in some aspects, process 1100 may include communicating using the single TCI state or the multiple TCI states, according to the indication, based at least in part on a starting repetition for a pattern of TCI state-to-repetition mapping (block 1120). For example, the UE (e.g., using communication manager 140, reception component 1302, and/or transmission component 1304, depicted in FIG. 13) may communicate using the single TCI state or the multiple TCI states, according to the indication, based at least in part on a starting repetition for a pattern of TCI state-to-repetition mapping, as described above.

Process 1100 may include additional aspects, such as any single aspect or any combination of aspects described below and/or in connection with one or more other processes described elsewhere herein.

In a first aspect, the plurality of repetitions are inter-slot repetitions.

In a second aspect, alone or in combination with the first aspect, the indication is to switch from single-TRP communication using the single TCI state to multi-TRP communication using the multiple TCI states, and the starting repetition for the pattern is a first repetition of the plurality of repetitions.

In a third aspect, alone or in combination with the first aspect, the indication is to switch from single-TRP communication using the single TCI state to multi-TRP communication using the multiple TCI states, and the starting repetition for the pattern is a first repetition, of the plurality of repetitions, following the time.

In a fourth aspect, alone or in combination with the first aspect, the indication is to switch from multi-TRP communication using the multiple TCI states to single-TRP communication using the single TCI state, and the starting repetition for the pattern is a first repetition of a plurality of subsequent repetitions.

In a fifth aspect, alone or in combination with the first aspect, the indication is to switch from multi-TRP communication using the multiple TCI states to single-TRP communication using the single TCI state, and the starting repetition for the pattern is a first repetition, of the plurality of repetitions, following the time.

In a sixth aspect, alone or in combination with one or more of the first through fifth aspects, the communication is for a physical downlink shared channel, a physical uplink shared channel, or a physical uplink control channel.

In a seventh aspect, alone or in combination with one or more of the first through sixth aspects, the indication is a unified TCI indication in DCI or a MAC-CE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with TRP switching during repetitions.

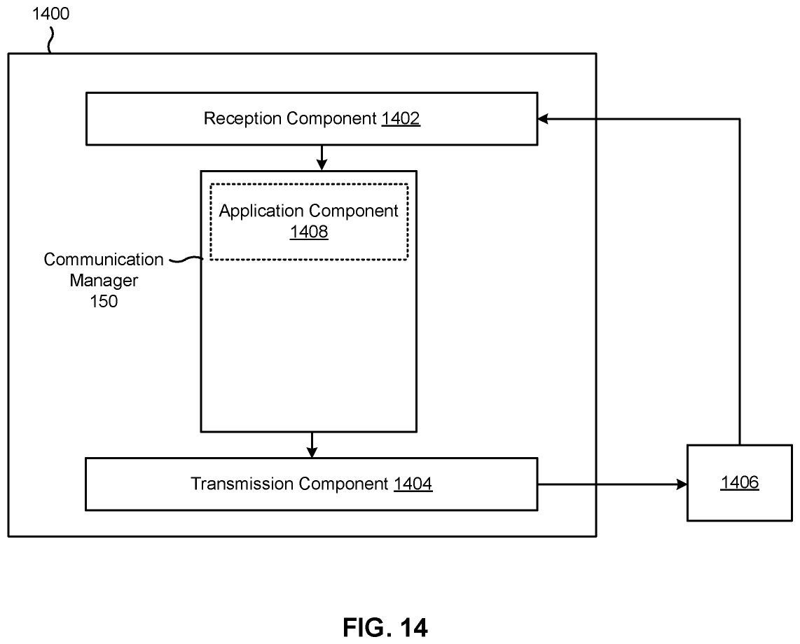

As shown in FIG. 12, in some aspects, process 1200 may include transmitting an indication to switch from multi-TRP communication using multiple TCI states to single-TRP communication using a single TCI state, or to switch from single-TRP communication using the single TCI state to multi-TRP communication using the multiple TCI states, the indication indicates a time for switching that is between repetitions of a plurality of repetitions of a communication (block 1210). For example, the network node (e.g., using communication manager 150 and/or transmission component 1404, depicted in FIG. 14) may transmit an indication to switch from multi-TRP communication using multiple TCI states to single-TRP communication using a single TCI state, or to switch from single-TRP communication using the single TCI state to multi-TRP communication using the multiple TCI states, the indication indicates a time for switching that is between repetitions of a plurality of repetitions of a communication, as described above.

As further shown in FIG. 12, in some aspects, process 1200 may include communicating, according to the indication, based at least in part on a starting repetition for a pattern of TCI state-to-repetition mapping (block 1220). For example, the network node (e.g., using communication manager 150, reception component 1402, and/or transmission component 1404, depicted in FIG. 14) may communicate, according to the indication, based at least in part on a starting repetition for a pattern of TCI state-to-repetition mapping, as described above.

Process 1200 may include additional aspects, such as any single aspect or any combination of aspects described below and/or in connection with one or more other processes described elsewhere herein.

In a first aspect, the plurality of repetitions are inter-slot repetitions.

In a second aspect, alone or in combination with the first aspect, the indication is to switch from single-TRP communication using the single TCI state to multi-TRP communication using the multiple TCI states, and the starting repetition for the pattern is a first repetition of the plurality of repetitions.

In a third aspect, alone or in combination with the first aspect, the indication is to switch from single-TRP communication using the single TCI state to multi-TRP communication using the multiple TCI states, and the starting repetition for the pattern is a first repetition, of the plurality of repetitions, following the time.

In a fourth aspect, alone or in combination with the first aspect, the indication is to switch from multi-TRP communication using the multiple TCI states to single-TRP communication using the single TCI state, and the starting repetition for the pattern is a first repetition of a plurality of subsequent repetitions.

In a fifth aspect, alone or in combination with the first aspect, the indication is to switch from multi-TRP communication using the multiple TCI states to single-TRP communication using the single TCI state, and the starting repetition for the pattern is a first repetition, of the plurality of repetitions, following the time.

In a sixth aspect, alone or in combination with one or more of the first through fifth aspects, the communication is for a physical downlink shared channel, a physical uplink shared channel, or a physical uplink control channel.

In a seventh aspect, alone or in combination with one or more of the first through sixth aspects, the indication is a unified TCI indication in DCI or a MAC-CE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include an application component 1308, among other examples.

In some aspects, the apparatus 1300 may be configured to perform one or more operations described herein in connection with FIGS. 8-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The application component 1308 may apply (e.g., configure the apparatus 1300 to use) the single TCI state or the multiple TCI states in accordance with the indication. The reception component 1302 and/or the transmission component 1304 may communicate using the single TCI state or the multiple TCI states, according to the indication, based at least in part on a starting repetition for a pattern of TCI state-to-repetition mapping.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include an application component 1408, among other examples.

In some aspects, the apparatus 1400 may be configured to perform one or more operations described herein in connection with FIGS. 8-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The transmission component 1404 may transmit an indication to switch from multi-TRP communication using multiple TCI states to single-TRP communication using a single TCI state, or to switch from single-TRP communication using the single TCI state to multi-TRP communication using the multiple TCI states. The indication may indicate a time for switching that is between repetitions of a plurality of repetitions of a communication. The application component 1408 may apply (e.g., configure the apparatus 1400 to use) the single TCI state or the multiple TCI states in accordance with the indication. The reception component 1402 and/or the transmission component 1404 may communicate, according to the indication, based at least in part on a starting repetition for a pattern of TCI state-to-repetition mapping.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by an apparatus of a user equipment (UE), comprising: receiving an indication to switch from multiple transmission reception point (multi-TRP) communication using multiple transmission configuration indicator (TCI) states to single-TRP communication using a single TCI state, or to switch from single-TRP communication using the single TCI state to multi-TRP communication using the multiple TCI states, the indication indicates a time for switching that is between repetitions of a plurality of repetitions of a communication; and communicating using the single TCI state or the multiple TCI states, according to the indication, based at least in part on a starting repetition for a pattern of TCI state-to-repetition mapping.

Aspect 2: The method of Aspect 1, wherein the plurality of repetitions are inter-slot repetitions.

Aspect 3: The method of any of Aspects 1-2, wherein the indication is to switch from single-TRP communication using the single TCI state to multi-TRP communication using the multiple TCI states, and wherein the starting repetition for the pattern is a first repetition of the plurality of repetitions.

Aspect 4: The method of any of Aspects 1-2, wherein the indication is to switch from single-TRP communication using the single TCI state to multi-TRP communication using the multiple TCI states, and wherein the starting repetition for the pattern is a first repetition, of the plurality of repetitions, following the time.

Aspect 5: The method of any of Aspects 1-2, wherein the indication is to switch from multi-TRP communication using the multiple TCI states to single-TRP communication using the single TCI state, and wherein the starting repetition for the pattern is a first repetition of a plurality of subsequent repetitions.

Aspect 6: The method of any of Aspects 1-2, wherein the indication is to switch from multi-TRP communication using the multiple TCI states to single-TRP communication using the single TCI state, and wherein the starting repetition for the pattern is a first repetition, of the plurality of repetitions, following the time.

Aspect 7: The method of any of Aspects 1-6, wherein the communication is for a physical downlink shared channel, a physical uplink shared channel, or a physical uplink control channel.

Aspect 8: The method of any of Aspects 1-7, wherein the indication is a unified TCI indication in downlink control information or a medium access control control element (MAC-CE).

Aspect 9: A method of wireless communication performed by an apparatus of a network node, comprising: transmitting an indication to switch from multiple transmission reception point (multi-TRP) communication using multiple transmission configuration indicator (TCI) states to single-TRP communication using a single TCI state, or to switch from single-TRP communication using the single TCI state to multi-TRP communication using the multiple TCI states, the indication indicates a time for switching that is between repetitions of a plurality of repetitions of a communication; and communicating, according to the indication, based at least in part on a starting repetition for a pattern of TCI state-to-repetition mapping.

Aspect 10: The method of Aspect 9, wherein the plurality of repetitions are inter-slot repetitions.

Aspect 11: The method of any of Aspects 9-10, wherein the indication is to switch from single-TRP communication using the single TCI state to multi-TRP communication using the multiple TCI states, and wherein the starting repetition for the pattern is a first repetition of the plurality of repetitions.

Aspect 12: The method of any of Aspects 9-10, wherein the indication is to switch from single-TRP communication using the single TCI state to multi-TRP communication using the multiple TCI states, and wherein the starting repetition for the pattern is a first repetition, of the plurality of repetitions, following the time.

Aspect 13: The method of any of Aspects 9-10, wherein the indication is to switch from multi-TRP communication using the multiple TCI states to single-TRP communication using the single TCI state, and wherein the starting repetition for the pattern is a first repetition of a plurality of subsequent repetitions.

Aspect 14: The method of any of Aspects 9-10, wherein the indication is to switch from multi-TRP communication using the multiple TCI states to single-TRP communication using the single TCI state, and wherein the starting repetition for the pattern is a first repetition, of the plurality of repetitions, following the time.

Aspect 15: The method of any of Aspects 9-14, wherein the communication is for a physical downlink shared channel, a physical uplink shared channel, or a physical uplink control channel.

Aspect 16: The method of any of Aspects 9-15, wherein the indication is a unified TCI indication in downlink control information or a medium access control control element (MAC-CE).

Aspect 17: An apparatus for wireless communication at a device, comprising a processor; memory coupled with the processor; and instructions stored in the memory and executable by the processor to cause the apparatus to perform the method of one or more of Aspects 1-8.

Aspect 18: A device for wireless communication, comprising a memory and one or more processors coupled to the memory, the one or more processors configured to perform the method of one or more of Aspects 1-8.

Aspect 19: An apparatus for wireless communication, comprising at least one means for performing the method of one or more of Aspects 1-8.

Aspect 20: A non-transitory computer-readable medium storing code for wireless communication, the code comprising instructions executable by a processor to perform the method of one or more of Aspects 1-8.

Aspect 21: A non-transitory computer-readable medium storing a set of instructions for wireless communication, the set of instructions comprising one or more instructions that, when executed by one or more processors of a device, cause the device to perform the method of one or more of Aspects 1-8.

Aspect 22: An apparatus for wireless communication at a device, comprising a processor; memory coupled with the processor, and instructions stored in the memory and executable by the processor to cause the apparatus to perform the method of one or more of Aspects 9-16.

Aspect 23: A device for wireless communication, comprising a memory and one or more processors coupled to the memory, the one or more processors configured to perform the method of one or more of Aspects 9-16.

Aspect 24: An apparatus for wireless communication, comprising at least one means for performing the method of one or more of Aspects 9-16.

Aspect 25: A non-transitory computer-readable medium storing code for wireless communication, the code comprising instructions executable by a processor to perform the method of one or more of Aspects 9-16.

Aspect 26: A non-transitory computer-readable medium storing a set of instructions for wireless communication, the set of instructions comprising one or more instructions that, when executed by one or more processors of a device, cause the device to perform the method of one or more of Aspects 9-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a +b, a +c, b +c, and a +b +c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A method of wireless communication performed by an apparatus of a user equipment (UE), comprising:
receiving an indication to switch from multiple transmission reception point (multi-TRP) communication using multiple transmission configuration indicator (TCI) states to single-TRP communication using a single TCI state, or to switch from single-TRP communication using the single TCI state to multi-TRP communication using the multiple TCI states,
the indication indicates a time for switching that is between repetitions of a plurality of repetitions of a communication; and
communicating using the single TCI state or the multiple TCI states, according to the indication, based at least in part on a starting repetition for a pattern of TCI state-to-repetition mapping.

2. The method of claim 1, wherein the plurality of repetitions are inter-slot repetitions.

3. The method of claim 1, wherein the indication is to switch from single-TRP communication using the single TCI state to multi-TRP communication using the multiple TCI states, and
wherein the starting repetition for the pattern is a first repetition of the plurality of repetitions.

4. The method of claim 1, wherein the indication is to switch from single-TRP communication using the single TCI state to multi-TRP communication using the multiple TCI states, and
wherein the starting repetition for the pattern is a first repetition, of the plurality of repetitions, following the time.

5. The method of claim 1, wherein the indication is to switch from multi-TRP communication using the multiple TCI states to single-TRP communication using the single TCI state, and
wherein the starting repetition for the pattern is a first repetition of a plurality of subsequent repetitions.

6. The method of claim 1, wherein the indication is to switch from multi-TRP communication using the multiple TCI states to single-TRP communication using the single TCI state, and
wherein the starting repetition for the pattern is a first repetition, of the plurality of repetitions, following the time.

7. The method of claim 1, wherein the communication is for a physical downlink shared channel, a physical uplink shared channel, or a physical uplink control channel.

8. The method of claim 1, wherein the indication is a unified TCI indication in downlink control information or a medium access control control element (MAC-CE).

9.-16. (canceled)

17. An apparatus for wireless communication at a user equipment (UE), comprising:
a memory; and
one or more processors, coupled to the memory, configured to:
receive an indication to switch from multiple transmission reception point (multi-TRP) communication using multiple transmission configuration indicator (TCI) states to single-TRP communication using a single TCI state, or to switch from single-TRP communication using the single TCI state to multi-TRP communication using the multiple TCI states, the indication indicates a time for switching that is between repetitions of a plurality of repetitions of a communication; and
communicate using the single TCI state or the multiple TCI states, according to the indication, based at least in part on a starting repetition for a pattern of TCI state-to-repetition mapping.

18. The apparatus of claim 17, wherein the plurality of repetitions are inter-slot repetitions.

19. The apparatus of claim 17, wherein the indication is to switch from single-TRP communication using the single TCI state to multi-TRP communication using the multiple TCI states, and
wherein the starting repetition for the pattern is a first repetition of the plurality of repetitions.

20. The apparatus of claim 17, wherein the indication is to switch from single-TRP communication using the single TCI state to multi-TRP communication using the multiple TCI states, and
wherein the starting repetition for the pattern is a first repetition, of the plurality of repetitions, following the time.

21. The apparatus of claim 17, wherein the indication is to switch from multi-TRP communication using the multiple TCI states to single-TRP communication using the single TCI state, and
wherein the starting repetition for the pattern is a first repetition of a plurality of subsequent repetitions.

22. The apparatus of claim 17, wherein the indication is to switch from multi-TRP communication using the multiple TCI states to single-TRP communication using the single TCI state, and
wherein the starting repetition for the pattern is a first repetition, of the plurality of repetitions, following the time.

23. The apparatus of claim 17, wherein the indication is a unified TCI indication in downlink control information or a medium access control control element (MAC-CE).

24.-30. (canceled)
